(19) United States
(12) Patent Application Publication
(10) Pub. No.: US 2016/0219331 A1
(43) Pub. Date: Jul. 28, 2016

(54) WAKEUP MESSAGE FOR A DIGITAL TELEVISION SYSTEM

(71) Applicant: THOMSON LICENSING, Issy les Moulineaux (FR)

(72) Inventors: John Sidney STEWART, Indianapolis, IN (US); Max Ward MUTERSPAUGH, Westfield, IN (US); Loic FONTAINE, Noyal-sur-Vilaine (FR)

(21) Appl. No.: 14/913,415

(22) PCT Filed: Aug. 19, 2014
(86) PCT No.: PCT/US2014/051658

§ 371 Date: Feb. 22, 2016

Related U.S. Application Data
(60) Provisional application No. 61/868,847, filed on Aug. 22, 2013.
(60) Provisional application No. 61/869,143, filed on Aug. 23, 2013.
(60) Provisional application No. 61/882,827, filed on Sep. 26, 2013.
(60) Provisional application No. 61/891,563, filed on Oct. 16, 2013.

(51) Int. Cl. H04N 21/443; H04N 21/434; H04N 21/2383; H04N 21/438; H04N 21/81; H04N 21/236

(52) U.S. Cl. CPC H04N 21/4432; H04N 21/814; H04N 21/4436; H04N 21/23614; H04N 21/2383; H04N 21/4382; H04N 21/4348

(57) ABSTRACT

Methods and apparatuses are provided which utilize the preamble of a multi-carrier modulated digital transmitted signal to indicate whether or not a special message (e.g., Emergency Alert System messages) is available for reception. When in power saving mode the receiver periodically detects the preamble, which requires limited functionality and power, to check for the presence of such special messages. The receiver only completely wakes up additional functionalities if a special message is detected in the preamble. This results in advantageous savings in power consumption, particularly for portable and handheld devices, while having the capability of receiving special messages anytime.

### CROSS-REFERENCE TO RELATED APPLICATIONS

This application claims the benefit of and priority to the U.S. Provisional Patent Applications: Ser. No. 61/868,847 and titled “WAKEUP MESSAGE FOR A DIGITAL TELEVISION SYSTEM”, filed on Aug. 22, 2013; Ser. No. 61/869,143 and titled “DIGITAL TELEVISION SIGNAL APPARATUS AND METHOD”, filed on Aug. 23, 2013; Ser. No. 61/882,827 and titled “DIGITAL TELEVISION SIGNAL APPARATUS AND METHOD”, filed on Sep. 26, 2013; and Ser. No. 61/891,563 and titled “METHOD AND APPARATUS FOR DELIVERING A BROADCAST DIGITAL TELEVISION SIGNAL”, filed on Oct. 16, 2013. The provisional applications are expressly incorporated by reference herein in their entirety for all purposes.

### TECHNICAL FIELD

The present principles relate to communication systems and in particular to wakeup messages in digital television systems.

### BACKGROUND

On Mar. 26, 2013, the Advanced Television Systems Committee (ATSC), which proposes terrestrial broadcasting digital television standards in the U.S., announced a call for proposals for the next generation (named ATSC 3.0) physical layer. ATSC 3.0 will provide even more services to the viewer and increased bandwidth efficiency and compression performance. This will require breaking backwards compatibility with the currently deployed version, ATSC A/53, which comprises an 8-VSB (8 level, Vestigial Sideband) modulation system. ATSC 3.0 is expected to emerge within the next decade and it intends to support delivery to fixed devices of content with video resolutions up to Ultra High Definition 3840×2160 at 60 frames per second (fps). The intention of the system is to support delivery to portable, handheld and vehicular devices of content with video resolution up to High Definition 1920×1080 at 60 fps. The system is also expected to support lower video resolutions and frame rates.

One of the main issues associated with the current ATSC standard is the vulnerability of the 8-VSB modulation system to multipath propagation and Doppler Effect. These impairments are present in the broadcast transmission environment, particularly in large metropolitan cities, and in the delivery to portable/handheld/vehicular devices (which ATSC intends to support). It is a consensus that multi-carrier modulation systems like, for example, the OFDM (orthogonal frequency division multiplex) modulation, are better choices of modulation to combat these impairments.

OFDM is a method of encoding digital data on multiple carrier frequencies. In OFDM, the sub-carrier frequencies are chosen so that the sub-carriers are orthogonal to each other, meaning that cross-talk between the sub-channels is eliminated and inter-carrier guard bands are not required. This greatly simplifies the design of both the transmitter and the receiver; unlike conventional FDM, a separate filter for each sub-channel is not required. The orthogonality allows for efficient modulator and demodulator implementation using the FFT (Fast Fourier Transform) algorithm on the receiver side, and inverse FFT on the transmitter side. In particular, the size of the FFT identifies the number of carriers in the OFDM modulation system. Frequency selective channels are characterized either by their delay spread or coherence bandwidth. In a single carrier system like 8-VSB, a single fade or interference can cause the whole link to fail, but in multi-carrier systems, like OFDM, only a few of the total sub carriers will be affected. This way, multipath fading can be easily eliminated in OFDM, with simpler equalization techniques than in single carrier systems.

When a new broadcast system is deployed in the US, as will eventually be the case for ATSC 3.0, one issue to consider is the requirement for broadcast systems to carry information related to the Emergency Alert System (EAS). The EAS is an American national public warning system that requires broadcasters, cable television systems, wireless cable systems, satellite digital audio radio service (SDARS) providers, and direct broadcast satellite (DBS) providers to provide the communications capability to the President to address the American public during a national emergency. The system may also be used by state and local authorities to deliver important emergency information, such as AMBER alerts (child abduction emergency) and weather information targeted to specific areas (e.g., tornadoes, blizzards, floods, etc.). Other countries may adopt similar systems.

For some receivers, in particular mobile and handheld devices, it is expensive in terms of energy consumption to keep the receiver powered up at all times to watch for this information. In many digital systems (e.g., DVB-T2 in Europe), a preamble is sent before the actual data, for each frame of data. The reason for the preamble signal is to allow for the receiver to quickly obtain timing and frequency lock as well as to describe the format of the data that follows (modulation parameters, FEC parameters, frame size, etc.). Typically, the preamble is constructed in such a way that it can be easily detected even when the receiver does not have timing and frequency lock.

The present principles propose to utilize the preamble of a multi-carrier (e.g., OFDM) based digital transmission system to indicate whether or not a special message (like the EAS messages) is available in the transmitted signal. As a result, the receiver periodically checks the preamble, which requires limited functionality and power and only completely wakes up if such a special message is detected. This results in power savings, particularly for portable and handheld devices.

### SUMMARY

The present principles provide methods and apparatuses which utilize the preamble of a multi-carrier modulation digital transmission system to indicate whether or not a special message (e.g., Emergency Alert System messages) is available for reception. When in power saving mode, the receiver periodically detects the preamble, which requires limited functionality and power, to check for the presence of such special messages. The receiver only completely wakes up additional functionalities if a special message is detected in the preamble. This results in advantageous savings in power consumption, particularly for portable and handheld devices, while having the capability of receiving special messages anytime.

According to one aspect of the present principles, an apparatus for transmitting a multi-carrier modulated signal is provided including: a source (111, 300) for providing data, the data divided into frames and including a wakeup message parameter which identifies whether or not a special message is included in the data; and a multi-carrier modulator (114) for modulating the data by allocating the data to a plurality of carriers in a plurality of modulation symbols, wherein the wakeup message parameter is included in a preamble symbol of a frame of data. The apparatus can further include a channel encoder (113) for channel encoding the data prior to the multi-carrier modulator.

According to one aspect of the present principles, an apparatus for receiving a multi-carrier modulated signal in power saving mode is provided, the apparatus including: a multi-carrier demodulator (124, 410) for periodically demodulating at least one preamble symbol of the modulated signal to create at least one demodulated preamble symbol, the at least one preamble symbol being at least one of a plurality of modulated symbols in a signal frame; and a signaling data detector (422) for detecting preamble data from the at least one demodulated preamble symbol and for recovering a wakeup message parameter from the preamble data, wherein the wakeup message parameter identifies whether or not a special message is included in the modulated signal. The signaling data detector may further wake up additional functional blocks if the special message is included, including: the multi-carrier demodulator (124, 410) for further demodulating additional modulated symbols of the modulated signal to recover the special message; and a display device to display the special message. The apparatus may further include a channel decoder (123, 420) for channel decoding the output of the multi-carrier demodulator prior to recovering the wakeup message parameter. The apparatus may further include a channel decoder (123, 420) for channel decoding the output of the multi-carrier demodulator prior to recovering the special message.

According to an aspect of the present principles, a method for transmitting a multi-carrier modulated signal is provided including: providing data (510), the data divided into frames and including a wakeup message parameter (520) which identifies whether or not a special message is included in the data; and modulating (540) the data by allocating the data to a plurality of carriers in a plurality of modulation symbols, wherein the wakeup message parameter is included in a preamble symbol of a frame of data. The method may further include channel encoding (540) the data prior to the step of modulating.

According to an aspect of the present principles, a method for receiving a multi-carrier modulated signal in power saving mode, the method including: periodically demodulating (610, 620) at least one preamble symbol of the modulated signal to create at least one demodulated preamble symbol, the at least one preamble symbol being at least one of a plurality of modulated symbols in a signal frame; and detecting preamble data (620) from the at least one demodulated preamble symbol; and recovering a wakeup message parameter (620) from the preamble data, wherein the wakeup message parameter identifies whether or not a special message (630) is included in the modulated signal. The method may further include: waking up additional functionalities (640) if the special message is included, including: demodulating additional modulated symbols of the modulated signal to recover the special message (650); and displaying the special message. The method may further include: channel decoding (620) after the step of demodulating and prior to recovering the wakeup message parameter. The method may further include channel decoding (620) after the step of demodulating and prior to recovering the special message.

In addition, according to one aspect of the present principles, the wakeup message parameter may include at least 1 bit. The wakeup message parameter may include unused bit combinations in the preamble data. The wakeup message parameter may further identify the type of message. The multi-carrier modulation may be OFDM.

Additional features and advantages of the present principles will be made apparent from the following detailed description of illustrative embodiments which proceeds with reference to the accompanying figures.

### BRIEF DESCRIPTION OF THE DRAWINGS

The present principles may be better understood in accordance with the following exemplary figures briefly described below:

FIG. 1 illustrates a simplified block diagram of a general digital communication system applicable to the digital broadcasting channel;

FIG. 2 illustrates the frame structure of a DVB-T2 digital television system;

FIG. 3 illustrates an exemplary transmitter source according to the present principles;

FIG. 4 illustrates an exemplary demodulator and channel decoder according to the present principles;

FIG. 5 illustrates a flowchart of a method for transmitting a signal according to the present principles; and

FIG. 6 illustrates a flowchart of a method for receiving a signal according to the present principles.

### DETAILED DISCUSSION OF THE EMBODIMENTS

The present principles relate to communication systems and in particular, to wakeup messages in digital television systems. Other than the inventive concept, several elements hereby discussed are well known and will not be described in detail. For example, other than the inventive concept, familiarity with the second generation digital terrestrial television broadcasting system for Digital Video Broadcasting (DVB-T2) is assumed and not described herein. In this regard, the standards and recommended practices of ETSI EN 302 755 and ETSI TS 102 832 are not described herein. Also, familiarity with the digital terrestrial television broadcasting system for the US (ATSC) is assumed and not described herein. In this regard, the standards and recommended practices of ATSC A/53, A/153 and A/54 are not described herein. Furthermore, familiarity with the US Emergency Alert System is assumed and not described herein. In this regard, the EAS Rules (47 C.F.R. Part 11) are not described herein. It should also be noted that the inventive concept may be implemented using conventional programming techniques, which, as such, will not be described herein.

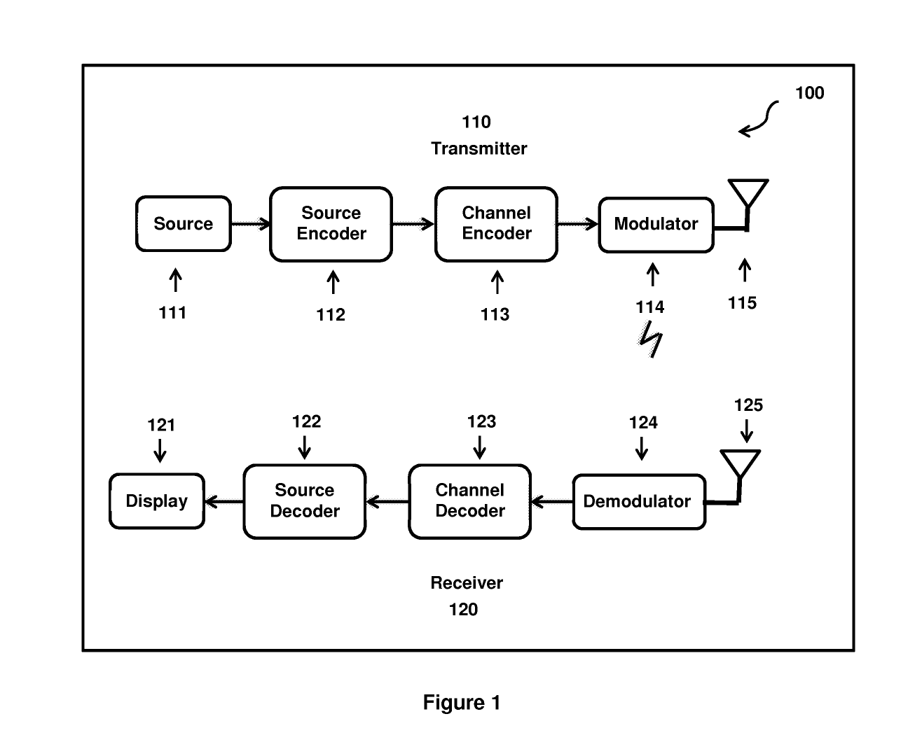

FIG. 1 shows a simplified block diagram 100 of a general digital communication system applicable to the digital broadcasting channel, independent of the modulation system and system architecture. The transmitter device 110 includes the following components:
a source 111 for the audio, video, signaling or control and other ancillary data (e.g., program guide);
a source encoder 112, including audio and video encoders to compress the audio and video data;
a channel encoder 113 including at least some of the functions of randomizing, interleaving, channel coding and frame mapping to process the compressed, signaling and ancillary digital data for robustness and to add levels of error correcting encoding functionality;

a modulator 114 to convert the processed digital data into modulation symbols, which can be, for example, VSB (ATSC) or OFDM (DVB-T2). In addition, it includes the functionality of filtering and digital-to-analog (D/A) conversion; and
an antenna 115 representing the functionalities of up-conversion, RF amplification and over-the-air broadcasting.

At the receiver device 120 of FIG. 1, the inverse functions of the transmitter are performed, including the following components:
an antenna for reception 125, which includes the functionalities of over-the-air reception, RF down-conversion and tuning;
a demodulator 124 to recover the digital data from the modulation symbols and includes the functionalities of analog-to-digital conversion (D/A), gain control, carrier and symbol timing recovery, equalization and header or preamble sync detection;
a channel decoder 123 to recover the compressed and ancillary data by performing the inverse functionalities of the channel encoder, including error correcting decoding, de-interleaving and de-randomizing;
a source decoder 122 to decompress the audio and video data, including video and audio decoders; and
a display device 121 for audio/video viewing.

A skilled artisan will appreciate that a source encoder 112 and a channel encoder 113, although common in general communications systems, are not essential for a system according to the present principles. Similarly, depending on the transmitter, a source decoder 122 and a channel decoder 123, although common in general communications systems, are not essential for a system according to the present principles. In addition, the transmitter and receiver may not require an antenna, if the transmission system is other than over-the-air (e.g., over cable). Furthermore, a receiving device includes, but is not limited to: a television, a set-top box, a computer, a mobile phone, an automobile receiver and a tablet.

One of the main issues associated with the current ATSC standard for digital terrestrial broadcasting of television in the US is the vulnerability of the 8-VSB modulation system to multipath propagation and Doppler Effect. These impairments are common in the broadcast transmission environment, particularly in large metropolitan cities, and in the delivery to portable/handheld/vehicular devices (which ATSC intends to support). It is a consensus that multi-carrier modulation systems like, for example, the OFDM (orthogonal frequency division multiplex) modulation are better choices of modulation to combat these impairments.

The OFDM modulation is adopted in other digital terrestrial television standards, e.g., the DVB-T/DVB-T2 standards in Europe, and the ISDB-T standard in Japan. DVB-T, the 1^{st} generation of European DTT (Digital Terrestrial Television), is the most widely adopted and deployed standard. Since its publication in 1997, over 70 countries have deployed DVB-T services and 45 more have adopted (but not yet deployed) DVB-T. This well-established standard benefits from massive economies of scale and very low receiver prices. Like its predecessor, DVB-T2 uses OFDM (orthogonal frequency division multiplex) modulation with a large number of sub-carriers delivering a robust signal, and offers a range of different modes, making it a very flexible standard. DVB-T2 uses the same error correction coding as used in DVB-S2 and DVB-C2: LDPC (Low Density Parity Check) coding combined with BCH (Bose-Chaudhuri-Hocquengham) coding, offering a very robust signal. The number of carriers, guard interval sizes and pilot signals can be adjusted, so that the overheads can be optimized for any target transmission channel. DVB-T2 offers more robustness, flexibility and at least 50% more efficiency than any other DTT system. It supports SD, HD, UHD, mobile TV, or any combination thereof.

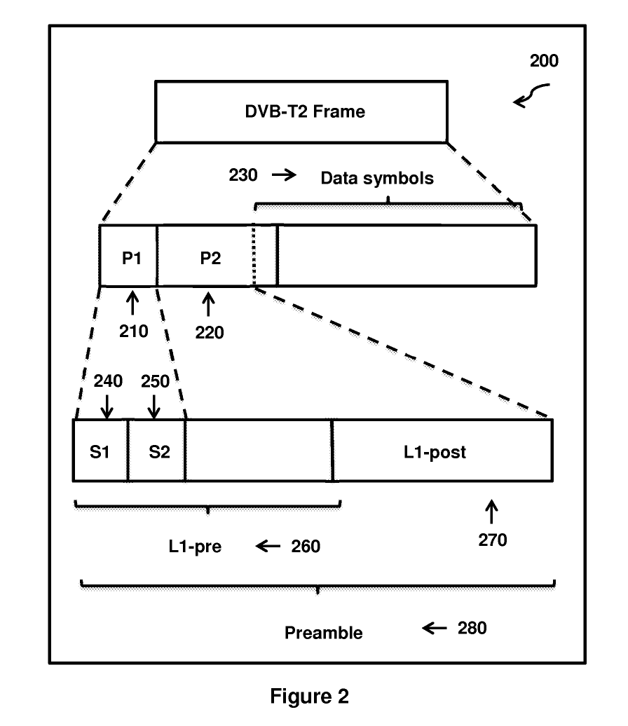

FIG. 2 shows the frame structure of a DVB-T2 system. The DVB-T2 frame 200 is composed of a preamble 280, followed by the data symbols 230. The preamble includes a P1 symbol 210 and a plurality of P2 symbols 220, depending on the amount of signaling information in the system. The signaling information is contained in two main blocks of data: L1-pre signaling 260 and L1-post signaling 270, each consisting of a plurality of parameters which define the system, including modulation parameters, FEC parameters, frame size, etc. Of the L1-pre signaling parameters, two important parameters constitute the P1 symbol: the S1 parameter 240 and the S2 parameter 250. The P1 symbol has the capability to convey 7 bits of signaling information (3 bits in S1 and 4 bits in S2). Since the preamble (comprising both P1 and P2 symbols) may have different formats, the main use of the P1 signaling is to identify the preamble itself. The information it carries is of two types: the first type (S1) is needed to distinguish the preamble format (and, hence the frame type); the second type (S2) helps the receiver to rapidly characterize the basic TX parameters, that is, the FFT size and the guard intervals. Besides being the first symbol of a DVB-T2 frame, the P1 symbol is a special symbol which has its own fixed FFT size to facilitate initial demodulation and detection.

Tables 1, 2 and 3 characterize the S1 and S2 parameters, respectively in the DVB-T2 most basic functionality. The tables show that bits S1(2) and S2(0) are not utilized. Extensions of the DVB-T2 standard have added additional functionalities and mapping of the bits, e.g., T2_LITE, and will not be discussed in this application. Table 3 is for the S2 parameter when S1 is X10 (non-T2) and Table 2 is for the other cases of the S1 parameter. A skilled artisan will appreciate that there are unused bits in S1 and S2, as well as reserved combinations, which result in a plurality of unused combinations in the 7 bits of the P1 symbol of the preamble.

TABLE 1

| S1 | Preamble Format/ | |
|---|---|---|
| (2, 1, 0) | P2 Type | Description |
| X00 | T2_SISO | T2 based preamble |
| | | P2 part is transmitted |
| | | in SISO mode |
| X01 | T2_MISO | T2 based preamble |
| | | P2 part is transmitted |
| | | in MISO mode |
| X10 | Non-T2 | Non-T2 based |
| | | preamble |
| X11 | Reserved | For future use |

When a new broadcast system is deployed in the US, as it will eventually be the case for ATSC 3.0, one issue to consider is the requirement for broadcast systems to carry information related to the Emergency Alert System (EAS). The EAS requires two primary components. The first is a simple and efficient method to signal that there is a pending EAS message and the second is the message itself. For some receivers, in particular portable, mobile and handheld devices, it is expensive in terms of energy consumption to keep the receiver powered up at all times to watch for this information. Since the system intends to support handheld and portable devices, it is of interest to insure that such devices save as much power as possible while still being capable of receiving EAS messages anytime.

TABLE 2

| S2 | | |
|---|---|---|
| (3, 2, 1, 0) | FFT\|GI size | Description |
| 000X | 2K\|any guard interval | FFT size and |
| | (GI) | guard intervals of |
| 001X | 8K\| 1/32, 1/16, ⅛ or | the remaining |
| | ¼ | symbols in the T2 |
| 010X | 4K\|any GI | frame |
| 011X | 1K\|any GI | |
| 100X | 16K\|any GI | |
| 101X | 32K\| 1/32, 1/16 or ⅛ | |
| 110X | 8K\| 1/128, 19/256 or | |
| | 19/128 | |
| 111X | 32K\| 1/128, 19/256 or | |
| | 19/128 | |

The present principles propose a way to utilize the preamble of a multi-carrier modulation digital system to indicate that there is an EAS message available in the transmitted signal. According to the present principles, apparatuses and methods are provided for a transmitter/transmitting and a receiver/receiving of a multi-carrier modulated signal which will transmit and receive special messages like the EAS messages. The transmitter transmits a signal comprising a preamble to permit fast and reliable initial acquisition, which includes a wakeup message to signal to the receiver that a special data message is being transmitted. At the receiver, a coarse demodulation and decoding is first performed to acquire the preamble and set other receiver parameters accordingly. This is efficient because it does not require the receiver to obtain full time/frequency synchronization to receive the data. A receiver can periodically wake-up, decode the preamble and go back to sleep if there is no “wake” signal in the wakeup message. In addition to EAS messages, this mechanism can be used for other services that require a device to wake up from a low-power mode. After acquisition of the preamble, the receiver identifies if there is a wakeup message in the transmission signal, which may prompt the receiver to power up additional functionalities in order to retrieve the special data message.

TABLE 3

| S2 | | |
|---|---|---|
| (3, 2, 1, 0) | Meaning | Description |
| 000X | Undefined FEF part | Preamble of a FEF |
| | | part |
| 001X-111X | Reserved | For future use |

According to the present principles, the wakeup message may comprise one or a plurality of bits. If the wakeup message comprises a plurality of bits, the wakeup message identifies whether or not a special message is present in the transmitted stream or signal, and the type of special message in the transmission stream, e.g., AMBER alert, weather related message, presidential message, acts of terrorism, accidents, etc.

In an exemplary embodiment of the present principles, the preamble may comprise a P1 symbol similar to the one in the DVB-t2 system. In one embodiment, the wakeup message may utilize an unused combination of the preamble bits. For example, by assigning S1(2) & S2(0) to a certain value, like “11”, this can indicate the presence of a special message in the stream (e.g., Amber alert). In another example, S1=“X10” and S2=“001X” to “111X” may signal a special frame just for special messages. A plurality of other unused combinations of the preamble bits may be chosen to identify the presence of special messages in the stream. Or additional bits may be added to the preamble for the sole purpose of wakeup messages. It will be appreciated that other frame structures, hence other preamble structures are implementable in accordance with the present principles.

In an exemplary embodiment of the present principles, if the wakeup message consists of one bit, the corresponding wakeup bit is assigned to the unused bit in the S2 field of the P1 symbol (S2(0)). In another embodiment, for a system without T2-LITE, the wakeup bit is assigned to the unused bit of the S1 field of the P1 symbol (S1(2)). For example, S1 bit 2 in Table 1 would have the following values: “0”=no emergency/special message available and “1”=emergency/special message available. In yet another embodiment, the wakeup bit is assigned to a new (8^{th}) bit in the P1 symbol. In another embodiment, the wakeup bit is assigned to an unused bit in a P2 symbol.

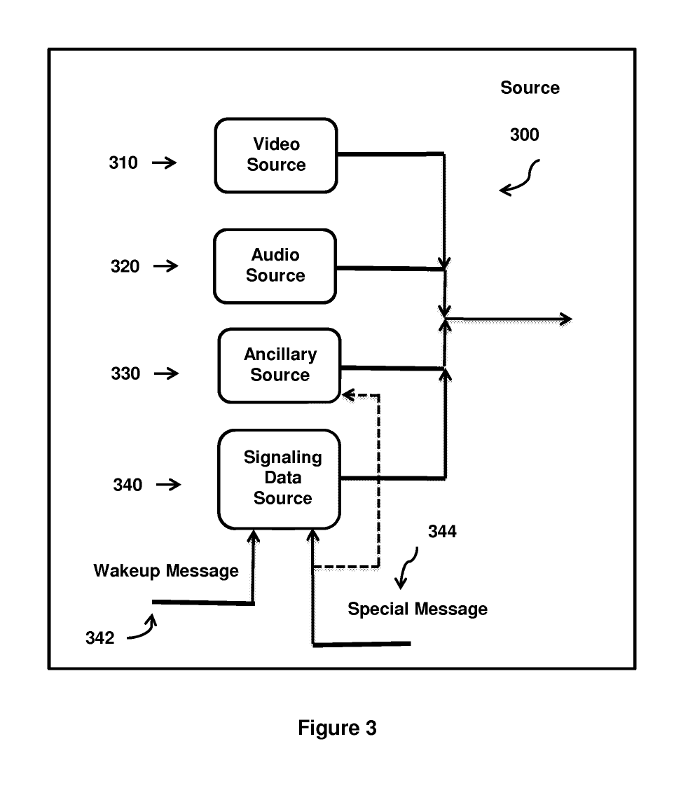

FIG. 3 shows additional details of the source 111 of FIG. 1, including the video source 310, audio source 320, other ancillary data source 330 and a signaling data source or generator 340. The various sources may not be co-located and may be provided via various forms of data links (e.g., satellite, cable, microwave). The signaling data source is a function of the communication system and may have a number of fixed parameters as well as variable parameters which can be provided via a user interface or another type of input (e.g., a file, a remote data link). According to the present principles, the signaling data source includes a wakeup message parameter 342 which identifies the presence and/or type of special messages present in the transmitted signal. Depending on the system, the signaling parameters may or not be channel encoded (in channel encoder 113). For example, in ATSC, signaling data like the field and segment sync are not channel encoded; in DVB-T2 all signaling parameters are channel encoded in the L1 pre and post signaling. The special message 344 is also provided via a user interface or another type of input and incorporated into the signaling or other ancillary data.

The modulator 114 according to the present principles creates a multi-carrier modulated signal, consisting of a sequence of modulation symbols, by allocating data to a plurality of carriers per modulation symbol, for signaling data and non-signaling data (video, audio, other ancillary data). In one embodiment of the present principles, the wakeup message parameter is sent in a preamble or header symbol for each frame of data, and is used to indicate the presence and/or type of the special message contained in the transmission signal.

At the receiver, the preamble symbol(s) is (are) first demodulated and the wakeup message parameter is recovered or extracted. If the presence of a special message is indicated, the receiver wakes up additional functionalities to receive the special message, which may include blocks associated with the reception of the data in the frame. Demodulation 124 is first performed to acquire the signaling data at a signaling data detector and set the receiver parameters accordingly. If the signaling data was channel encoded at the transmitter (at channel encoder 113), the signaling data detector must reside inside or after the channel decoder 123; otherwise, it can reside inside or after the demodulator 124. After the signaling data is recovered, the receiver extracts the various parameters contained in the signaling data to set its various modes of operation associated with its various data related blocks (including but not limited to modulation, e.g., constellation size, FFT size; FEC; interleaving; data distribution within the frame; etc.). The parameters are then sent to the various blocks in order for demodulation and decoding to be performed on the video, audio and other ancillary data.

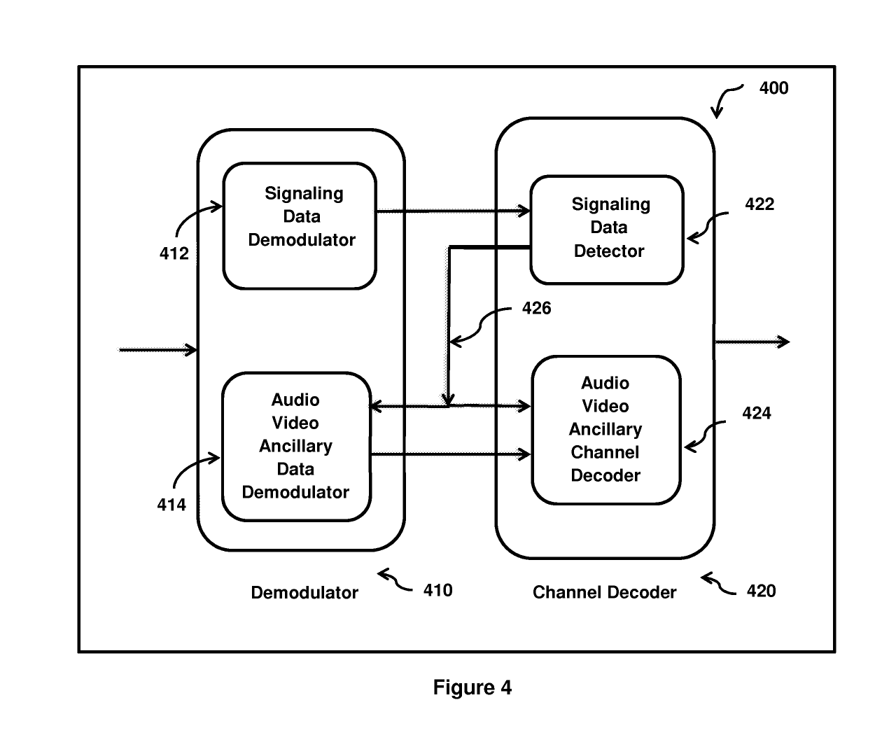

FIG. 4 shows an exemplary block diagram according to the present principles depicting a multi-carrier demodulator 410 and channel decoder 420. The demodulator 410, for all practical purposes, can be shown as composed of two blocks: the signaling data demodulator 412, which demodulates the signaling data symbols and sends the demodulated signaling data symbols to the signaling data detector 422. At the signaling data detector 422, the signaling data 326 is recovered from several potential levels of interleaving, randomizing and channel encoding for protection of the data against channel impairments. Once the signaling data 426 is recovered, it is then sent to other blocks of the receiver, including the audio/video/ancillary (non-signaling) data demodulator 414 and the audio/video/ancillary data channel decoder 424. These two blocks will demodulate and decode the audio, video and other ancillary (data other than signaling) data symbols as a function of the several signaling data parameters 426, including the wakeup message parameter.

In one embodiment of the present principles the transmitter establishes a minimum active time for the wakeup message to be set (that is, to identify that there is a special message) so that a receiver that is turned off or in a low or saving power mode can wake up only once during the active time and check the preamble wakeup message.

In one embodiment of the present principles, the transmitter sets the wakeup message for a prolonged period of time to insure that all receivers are able to receive it, regardless of battery or reception problems.

In one embodiment of the present principles, the transmitter sends the same special message more than once, at different times of the day. This implies alternate periods of turning the wakeup message on and off.

In one embodiment of the present principles, the transmitter changes the wakeup message (represented by an unused combination of the preamble bits) in a carrousel fashion when the special data message changes. This permits the receiver to skip a message that it has already received and remain in shut down or in low power mode for additional functionalities besides the preamble reception.

In one embodiment of the present principles, an interval of time is established for the receivers to repeatedly check the preamble for wakeup messages via a check timer.

In one embodiment of the present principles, the receiver identifies whether or not the special message has already been received. Once the special message associated with a wakeup message has been received, the receiver disregards the wakeup message, until the wakeup message changes. In another embodiment of the present principles, the receiver disregards a wakeup message if it has already received a wakeup message within a predetermined period of time.

In one embodiment, the multi-carrier modulated signal is a DVB-T2 type of signal, that is, a signal that has a frame, super-frame and physical layer pipe (PLP) architecture, modulation, FEC and signaling etc. defined similarly to DVB-T2, but with the addition of some important changes to accommodate new conditions and transmission systems not envisioned by the DVB-T2 standard body.

In one embodiment of the present principles, for a DVB-T2 or similar system, in order to make the processing of the emergency messages more efficient, two pieces of additional information are sent as part of the signaling data. These are a message version number and the Physical Layer Pipe (PLP) or virtual channel number where the emergency message can be found. This requires two new fields to be added to signaling data, for example, in the L1 pre signaling data of a DVB-T2 signal:
EAS VERSION: This 8-bit field indicates the current version of the emergency/special message. The version number is incremented by 1 for each change in the emergency/special message. If the wakeup message parameter signals that there is no special message, then this field should be set to 0.
EAS_PLP: This 8-bit field indicates the PLP where the emergency/special message information is carried. If the wakeup message parameter signals that there is no special message, then this field is undefined or set to 0. Also, if the special message is contained in the signaling data, this field is set to FF, for example, and an additional field for the special message is added to the signaling data with a predetermined number of bits, or a variable number of bits.

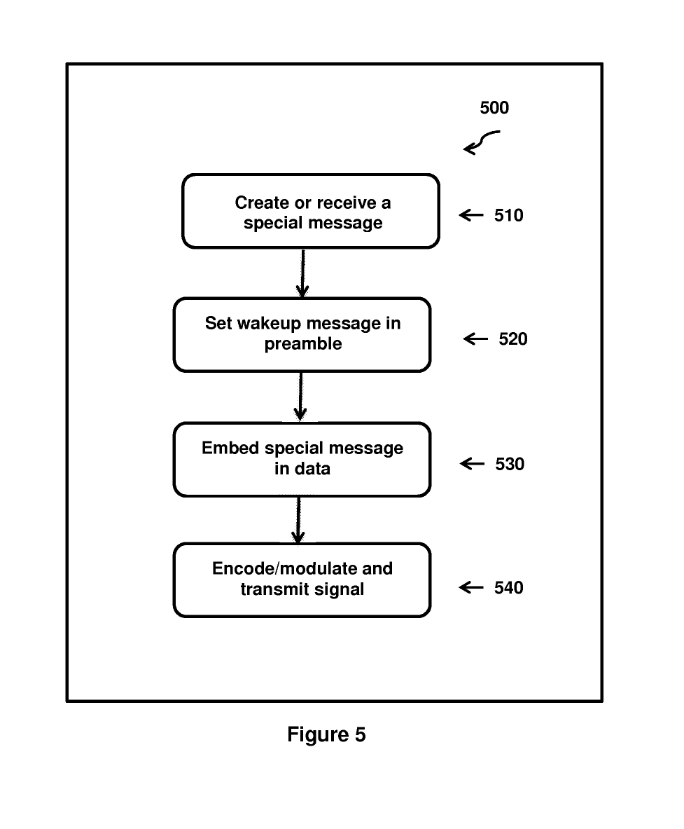

FIG. 5 shows a flowchart 500 of a method for transmitting a signal according to the present principles. Initially, a special message is created or received 510 at a data source as in 300 of FIG. 3. The wakeup message is also created or received and incorporated in the preamble data according to the presence of a special message 520 (e.g., set to ‘1’ to indicate presence; set to ‘0’ to indicate absence of a special message). The special message is then embedded in the signal data 530, either in the signaling data source or the other ancillary data source as shown in FIG. 3. Finally, the data is encoded and/or modulated and the signal is transmitted.

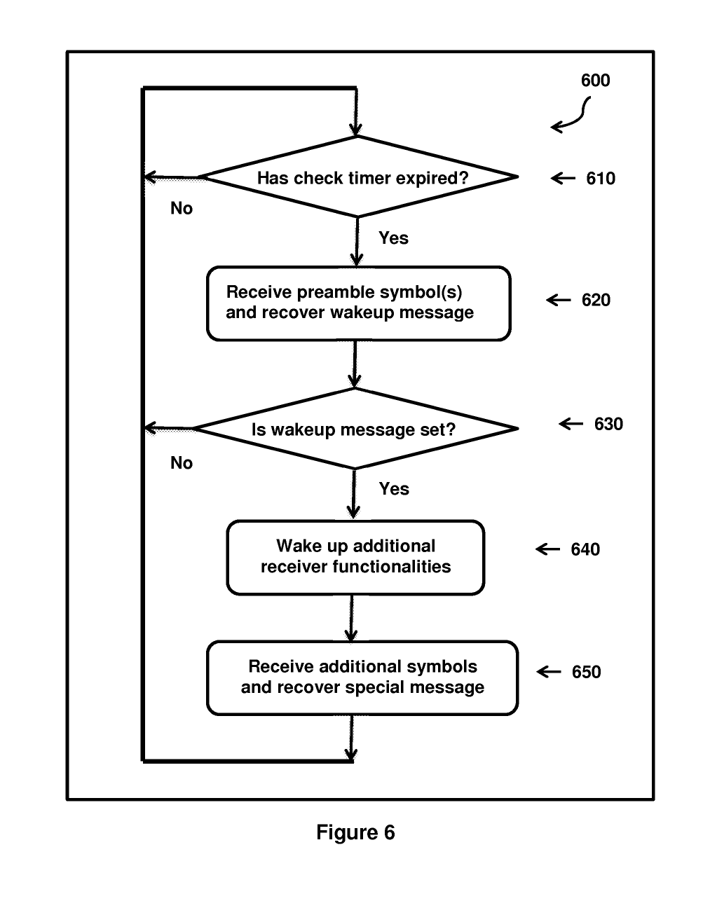

FIG. 6 shows a flowchart 600 of a method for receiving a signal according to the present principles. When in a power saving mode, the receiver periodically receives and demodulates the preamble symbol(s) to recover the wakeup message 620. The periodicity is established by a timer which can have a predetermined period 610. If the wakeup message is not set (that is, it identifies absence of a special message) 630, then the timer is restarted; otherwise, the receiver wakes up additional receiver functionalities 640 necessary to recover the special message. This implies demodulating and possibly channel decoding additional modulated symbols associated with the message, whether they are associated with additional signaling data or other ancillary data. Finally the special message is recovered and delivered to a display device 650.

In view of the above, the foregoing merely illustrates the present principles, and it will thus be appreciated that those skilled in the art will be able to devise numerous alternative arrangements which, although not explicitly described herein, embody the present principles and are within its spirit and scope. For example, although illustrated in the context of separate functional elements, the various functional elements of a transmitter and/or receiver may be embodied in one, or more, integrated circuits (ICs). Similarly, although shown as separate elements, any or all of the elements may be implemented in a stored-program-controlled processor, e.g., a digital signal processor, which executes associated software, e.g., corresponding to one, or more, of steps. In addition, the present principles may apply to other multi-carrier modulation systems besides OFDM, e.g., discrete multi-tone (DMT) and to other types of single-carrier or multi-carrier pre-existing or legacy systems besides 8-VSB, e.g., single carrier QAM modulation. Further, the present principles are applicable to other types of communications systems, e.g., Wireless-Fidelity (Wi-Fi), cellular, cable, satellite, etc. Indeed, the inventive concept is also applicable to stationary or mobile receivers. It is therefore to be understood that numerous modifications may be made to the illustrative embodiments and that other arrangements may be devised without departing from the spirit and scope of the present principles.

1. An apparatus for transmitting a multi-carrier modulated signal comprising:
a source (111, 300) for providing data, said data divided into frames and comprising a wakeup message parameter which identifies whether or not a special message is included in said data; and
a multi-carrier modulator (114) that modulates said data by allocating said data to a plurality of carriers in a plurality of modulation symbols, wherein the wakeup message parameter is included in at least one preamble symbol of a frame of data.

2. The apparatus according to claim 1 further comprising:
a channel encoder (113) for channel encoding said data prior to the multi-carrier modulator.

3. The apparatus according to claim 1 wherein the wakeup message parameter comprises at least 1 bit.

4. The apparatus according to claim 3 wherein the wakeup message parameter comprises unused bit combinations in the preamble.

5. The apparatus according to claim 3 wherein the wakeup message parameter further identifies the type of message.

6. The apparatus according to claim 1 wherein the multi-carrier modulation is OFDM.

7. An apparatus for receiving a multi-carrier modulated signal in power saving mode, said apparatus comprising:
a multi-carrier demodulator (124, 410) that periodically demodulates at least one preamble symbol of said modulated signal to create at least one demodulated preamble symbol, said at least one preamble symbol being at least one of a plurality of modulated symbols in a signal frame; and
a signaling data detector (422) that detects preamble data from said at least one demodulated preamble symbol and for recovering a wakeup message parameter from said preamble data, wherein said wakeup message parameter identifies whether or not a special message is included in said modulated signal.

8. The apparatus according to claim 7, wherein the signaling data detector further wakes up additional functional blocks if said special message is included, comprising:
the multi-carrier demodulator (124, 410) for further demodulating additional modulated symbols of said modulated signal to recover said special message; and
a display device to display said special message.

9. The apparatus according to claim 7 further comprising:
a channel decoder (123, 420) for channel decoding the output of the multi-carrier demodulator prior to recovering said wakeup message parameter.

10. The apparatus according to claim 8 further comprising:
a channel decoder (123, 420) for channel decoding the output of the multi-carrier demodulator prior to recovering said special message.

11. The apparatus according to claim 7 wherein the wakeup message parameter comprises at least 1 bit.

12. The apparatus according to claim 7 wherein the wakeup message parameter comprises unused bit combinations in the preamble data.

13. The apparatus according to claim 7 wherein the wakeup message parameter further identifies the type of message.

14. The apparatus according to claim 7 wherein the multi-carrier modulation is OFDM.

15. A method for transmitting a multi-carrier modulated signal comprising:
providing data (510), said data divided into frames and comprising a wakeup message parameter (520) which identifies whether or not a special message is included in said data; and
modulating (540) said data by allocating said data to a plurality of carriers in a plurality of modulation symbols, wherein the wakeup message parameter is included in at least one preamble symbol of a frame of data.

16. The method according to claim 15 further comprising:
channel encoding (540) said data prior to the step of modulating.

17. The method according to claim 15 wherein the wakeup message parameter comprises at least 1 bit.

18. The method according to claim 17 wherein the wakeup message parameter comprises unused bit combinations in the preamble.

19. The method according to claim 17 wherein the wakeup message parameter further identifies the type of message.

20. The method according to claim 15 wherein the multi-carrier modulation is OFDM.

21. A method for receiving a multi-carrier modulated signal in power saving mode, said method comprising:
periodically demodulating (610, 620) at least one preamble symbol of said modulated signal to create at least one demodulated preamble symbol, said at least one preamble symbol being at least one of a plurality of modulated symbols in a signal frame;
detecting preamble data (620) from said at least one demodulated preamble symbol; and
recovering a wakeup message parameter (620) from said preamble data, wherein said wakeup message parameter identifies whether or not a special message (630) is included in said modulated signal.

22. The method according to claim 21, further comprising:
waking up additional functionalities (640) if said special message is included, comprising:
demodulating additional modulated symbols of said modulated signal to recover said special message (650); and
displaying said special message.

23. The method according to claim 21 further comprising:
channel decoding (620) after the step of demodulating and prior to recovering said wakeup message parameter.

24. The method according to claim 22 further comprising:
channel decoding (620) after the step of demodulating and prior to recovering said special message.

25. The method according to claim 21 wherein the wakeup message parameter comprises at least 1 bit.

26. The method according to claim 21 wherein the wakeup message parameter comprises unused bit combinations in the preamble data.

27. The method according to claim 21 wherein the wakeup message parameter further identifies the type of message.

28. The method according to claim 21 wherein the multi-carrier modulation is OFDM.
